(19) United States
(12) Patent Application Publication
(10) Pub. No.: US 2025/0010238 A1
(43) Pub. Date: Jan. 9, 2025

(54) CO2 RECOVERY DEVICE

(71) Applicant: JTEKT CORPORATION, Kariya-shi (JP)

(72) Inventors: Kota NANRI, Nara (JP); Toshiyuki SAITO, Nara (JP)

(73) Assignee: JTEKT CORPORATION, Kariya-shi (JP)

(21) Appl. No.: 18/701,489

(22) PCT Filed: Oct. 29, 2021
(86) PCT No.: PCT/JP2021/040015

§ 371 Date: Sep. 30, 2024

(51) Int. Cl. B01D 53/62; B01D 53/18; C01D 7/07

(52) U.S. Cl. CPC B01D 53/62; B01D 53/18; C01D 7/07

(57) ABSTRACT

A CO₂ recovery device (1) includes a reaction tank (10), a CO2 gas supply unit (41), and a CO₂-removed gas discharge unit (42). The reaction tank (10) brings CO₂ gas into contact with an aqueous alkali metal hydroxide solution or an aqueous alkaline earth metal hydroxide solution. The CO₂ gas supply unit (41) supplies the CO₂ gas into the reaction tank 10. The CO₂-removed gas discharge unit (42) discharges CO₂-removed gas, from which CO₂ has been removed, from the reaction tank (10). The CO₂ gas supply unit (41) and the CO₂-removed gas discharge unit (42) are attached so as to be detachably attachable to the reaction tank (10).

### TECHNICAL FIELD

The present disclosure relates to a CO2 recovery device.

### BACKGROUND ART

In recent years, there has been demand for suppressing the emission of CO₂gas that is a greenhouse gas, and various devices for recovering CO₂ gas are being studied. For example, there is an arrangement as a CO₂ recovery device in which CO₂-containing exhaust gas from a power generation boiler or the like is made to react with a NaOH aqueous solution stored in a reaction tank, so as to generate NaHCO₃ or Na₂CO₃, thereby recovering the CO₂ from the exhaust gas. NaHCO₃, Na₂CO₃, and mixtures thereof generated by the CO₂recovery device can be used as resources. For example, Patent Document 1 discloses a configuration in which a reaction liquid obtained by spraying CO₂ gas into a NaOH aqueous solution in a large-scale reaction tank is sequentially transported to a solid-liquid separation device and a drying device, to obtain a product.

### Related Art Documents

### Patent Documents

Patent Document 1: Japanese Unexamined Patent Application Publication No. 2012-206872 (JP 2012-206872 A)

### SUMMARY OF THE INVENTION

In the configuration disclosed in Patent Document 1, a supply unit that supplies exhaust gas, and a discharge unit that discharges gas after removing CO₂, are inserted into the reaction tank through a lid member of the reaction tank, and are in a state of not being easily detached from the reaction tank. Accordingly, the reaction tank cannot be readily moved when retrieving the product from the reaction tank or when introducing the reaction liquid into the reaction tank, and hence, there are cases in which retrieving the product or introducing the reaction liquid is troublesome. In particular, when a small-sized reaction tank is used, the frequency of retrieving the product and introducing the reaction liquid tends to increase, which tends to be troublesome.

The present disclosure aims to provide a CO₂ recovery device that can reduce the trouble for retrieving products and introducing reaction liquids.

An aspect of the present disclosure is a CO₂ recovery device that includes a reaction tank in which CO₂ gas is brought into contact with an aqueous alkali metal hydroxide solution or an aqueous alkaline earth metal hydroxide solution, a CO₂ gas supply unit that supplies the CO₂ gas into the reaction tank, and a CO₂-removed gas discharge unit that discharges CO₂-removed gas, from which CO₂ has been removed, from the reaction tank.

The CO₂ gas supply unit and the CO₂-removed gas discharge unit are attached so as to be detachably attachable to the reaction tank.

### Effects of the Invention

In the above CO₂ recovery device, the CO₂ gas supply unit and the CO₂-removed gas discharge unit are attached so as to be detachably attachable to the reaction tank. Accordingly, the reaction tank can be moved or detached as necessary when retrieving the product or introducing the reaction liquid. Thus, the trouble to retrieve the product and to introduce the reaction liquid can be reduced.

As described above, according to the above aspect, a CO₂ recovery device can be provided that can reduce the trouble of retrieving the product and introducing the reaction liquid.

Note that the signs in parentheses in the claims indicate the correspondence with specific means described in the embodiments described below, and are not intended to limit the technical scope of the present disclosure.

### BRIEF DESCRIPTION OF THE DRAWINGS

The foregoing and other objects, features, and advantages of the present disclosure will become more apparent from the following detailed description when taken in conjunction with the accompanying drawings, wherein: in the drawings,

FIG. 1 is a conceptual diagram illustrating a configuration of a CO₂ recovery device according to Embodiment 1:

FIG. 2 is a cross-section conceptual diagram of a reaction tank according to Embodiment 1:

FIG. 3 is, in Embodiment 1, (a) a longitudinal-section conceptual view of a CO₂ gas supply unit, and (b) a cross-section conceptual view along position IIIb-IIIb position in (a):

FIG. 4 is a longitudinal-section conceptual view of a CO₂-removed gas discharge unit according to Embodiment 1:

FIG. 5 is a conceptual diagram illustrating a configuration of a CO₂ recovery device according to Embodiment 2:

FIG. 6 is a conceptual diagram illustrating a configuration of a CO₂ recovery device according to Embodiment 3:

FIG. 7 is, in Embodiment 4, (a) a conceptual diagram illustrating a configuration of a CO₂ recovery device, and (b) a perspective conceptual diagram of the same:

FIG. 8 is, in Embodiment 4, (a) a conceptual diagram illustrating a state before a lid member is connected, and (b) a conceptual diagram illustrating a state after the lid member is connected:

FIG. 9 is a cross-section conceptual diagram of a main body and a reaction tank according to Embodiment 5:

FIG. 10 is, in Embodiment 6, (a) a cross-section conceptual diagram illustrating a state in which a lid portion is attached to a reaction tank, and (b) a cross-section conceptual diagram illustrating a state in which the lid portion is detached from the reaction tank:

FIG. 11 is a conceptual diagram illustrating a configuration of a CO₂ recovery device according to Embodiment 7:

FIG. 12 is, in Embodiment 8, (a) a cross-section conceptual diagram illustrating a state in which a lid portion is attached to a reaction tank, and (b) a cross-section conceptual diagram illustrating a state in which the lid portion is detached from the reaction tank:

FIG. 13 is, in Embodiment 8, (a) a cross-section conceptual view of an opening/closing mechanism, and (b) a cross-section conceptual view along position XIIIb-XIIIb position in (a):

FIG. 14 is, in Embodiment 8, (a) a top perspective view of a blade member, (b) a bottom perspective view of the blade member, and (c) a top perspective view of a regulating plate:

FIG. 15 is a partial top perspective view of the reaction tank according to Embodiment 8:

FIG. 16 is, with regard to the opening/closing mechanism in Embodiment 8, (a) a conceptual diagram illustrating a completely closed state, (b) a conceptual diagram illustrating a partially open state, and (c) a conceptual diagram illustrating a completely open state:

FIG. 17 is a longitudinal-section conceptual diagram of an opening/closing mechanism according to a modification:

FIG. 18 is a conceptual diagram illustrating a configuration of a CO₂ recovery device according to Embodiment 9; and

FIG. 19 is another conceptual diagram illustrating the configuration of the CO₂ recovery device according to Embodiment 9.

### MODES FOR CARRYING OUT THE INVENTION

### (Embodiment 1)

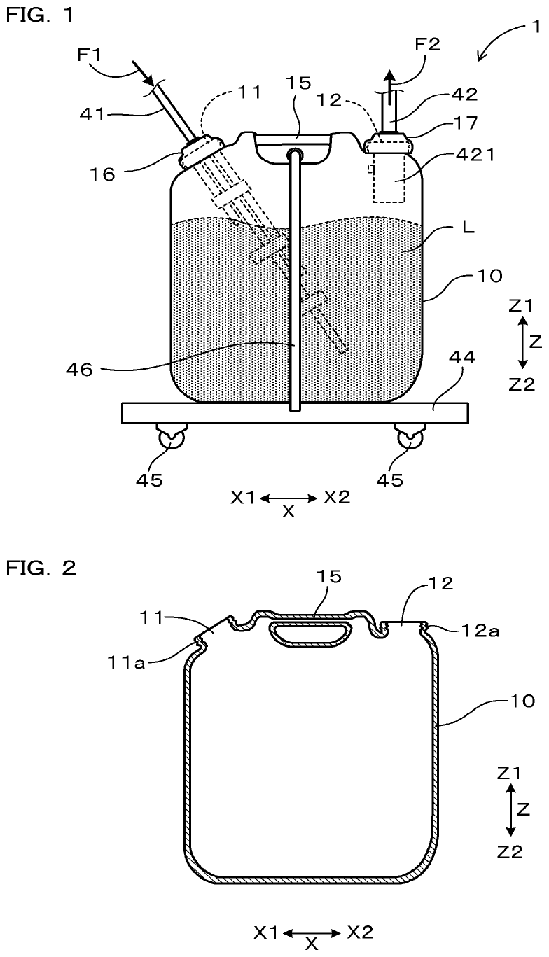

An embodiment of a CO₂ recovery system will be described with reference to FIG. 1 to FIG. 4.

As illustrated in FIG. 1, a CO₂ recovery device 1 according to Embodiment 1 includes a reaction tank 10, a CO₂ gas supply unit 41, and a CO₂-removed gas discharge unit 42.

The reaction tank 10 brings CO₂ gas into contact with an aqueous alkali metal hydroxide solution or an aqueous alkaline earth metal hydroxide solution.

The CO₂ gas supply unit 41 supplies the CO₂ gas into the reaction tank 10.

The CO₂-removed gas discharge unit 42 discharges CO₂-removed gas, from which CO₂ has been removed, from the reaction tank 10.

The CO₂ gas supply unit 41 and the CO₂-removed gas discharge unit 42 are attached so as to be detachably attachable to the reaction tank 10.

The CO₂ recovery device 1 according to the present embodiment will be described below in detail.

As illustrated in FIG. 1, the CO₂ recovery device 1 includes the reaction tank 10. The reaction tank 10 is configured so that an aqueous solution L can be stored therein. The material of the reaction tank 10 is not limited in particular, as long as it has alkali resistance. In the present embodiment, the reaction tank 10 that is used is a polyethylene container, and is a so-called commercially-available general-purpose polyethylene tank. This polyethylene tank is intended to be used as a container for transporting and storing liquids therein, such as for example, drinking water, kerosene, waste water, and so forth. The capacity of the polyethylene tank used as the reaction tank 10 is not limited, but one having a capacity of 10to 20 L can usually be used.

As illustrated in FIG. 1 and FIG. 2, the reaction tank 10 has a first opening portion 11 and a second opening portion 12. Note that in FIG. 1 and FIG. 2, a vertical direction is Z, a width direction is X, and a front-rear direction is Y. In the vertical direction Z, an upward side is Z1 and a downward side is Z2. Also, in the width direction X, one direction is X1, and a direction opposite to the X1 direction is X2. As illustrated in FIG. 1, the reaction tank 10 is placed on a truck 44 having tires 45, and is restrained by a restraining band 46 to the truck 44 so as not to shift relative to the truck 44. The reaction tank 10 can be easily moved by the truck 44, even in a state in which the aqueous solution L is stored therein.

As illustrated in FIG. 2, both the first opening portion 11 and the second

opening portion 12 are provided on an upper face of the reaction tank 10 upward Z1 in the vertical direction. On the upper face of the reaction tank 10, the first opening portion 11 is provided on one side X1 in the width direction X, and the second opening portion 12 is provided on the other side X2 in the width direction X. An opening direction of the first opening portion 11 is inclined toward one side X1 in the width direction with respect to the vertical direction Z, and an opening direction of the second opening portion 12 is parallel to the vertical direction Z. The first opening portion 11 includes a threaded portion 11a that extends in a cylindrical shape and also includes a groove on an outer peripheral face thereof. Similarly, the second opening portion 12 has a threaded portion 12a that extends in a cylindrical shape and also includes a groove on an outer peripheral face thereof. A handle 15 is provided between the first opening portion 11 and the second opening portion 12 on the upper face of the reaction tank 10. The handle 15 is integrally molded with the reaction tank 10.

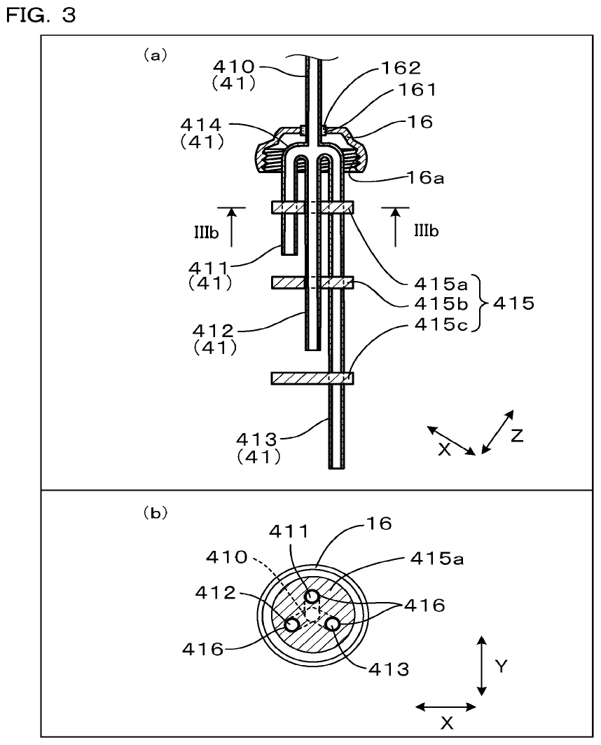

As illustrated in FIG. 1, the first opening portion 11 is covered by a first lid member 16. As illustrated in FIG. 3(a), the first lid member 16 has a threaded portion 16a inside that has a groove that follows the shape of the threaded portion 11a of the first opening portion 11. By placing the first lid member 16 over the first opening portion 11 illustrated in FIG. 2, and turning the first lid member 16, the threaded portions 11a and 16a of the two are screwed to each other, and the first lid member 16 is attached so as to be detachably attachable to the reaction tank 10 as illustrated in FIG. 1.

As illustrated in FIG. 1 and FIG. 3(a), the first lid member 16 is provided with the CO₂ gas supply unit 41. The CO₂ gas supply unit 41 includes an outwardly extending portion 410 that is inserted into a through hole 161 formed in the first lid member 16 and that extends outside the reaction tank 10, nozzle portions 411 to 413 that extend into the reaction tank 10, and a connecting portion 414 that performs connection thereof. As illustrated in FIG. 3(a), the outwardly extending portion 410 branches into three nozzle portions 411 to 413 at the connecting portion 414. Note that the outwardly extending portion 410 is loosely fitted into the through hole 161 and is not fixed to the first lid member 16. Accordingly, even when the first lid member 16 is rotated when attaching the first lid member 16 to the first opening portion 11, the outwardly extending portion 410 can be kept from rotating. Note that a bush 162 that is cylindrical is provided in the through hole 161, and airtightness between the outwardly extending portion 410 and the first lid member 16 is maintained.

As illustrated in FIG. 3(a), the CO₂ gas supply unit 41 has a first nozzle portion 411, a second nozzle portion 412, and a third nozzle portion 413, in order of length. Accordingly, as illustrated in FIG. 1, distal ends of the nozzle portions 411 to 413 are respectively located at different positions in the vertical direction Z in the reaction tank 10.

Relative positions of the three nozzle portions 411 to 413 as to each other are fixed by a support plate 415. Three support plates 415 are provided, with a first support plate 415a, a second support plate 415b, and a third support plate 415c being positioned at equal intervals from the side closest to the first lid member 16. As illustrated in FIG. 3(b), the nozzle portions 411 to 413 are each inserted into through holes 416 provided in the first support plate 415a. Note that as illustrated in FIG. 3(a), the second nozzle portion 412 and the third nozzle portion 413 are inserted through the second support plate 415b, and only the third nozzle portion 413 is inserted through the third support plate 415c. When gas discharged from the distal ends of the nozzle portions 411 to 413 in the aqueous solution L exhibits upward movement, the support plate 415 can interfere with this upward movement, and can diffuse the gas into the aqueous solution L.

The CO₂ gas supply unit 41 is configured to supply CO₂ gas into the reaction tank 10. In the present embodiment, a duct (omitted from illustration) through which CO₂ gas flows is connected to the CO₂ gas supply unit 41, and is configured such that CO₂ gas is discharged into the reaction tank 10 due to the pressure of the CO₂ gas flowing through the duct.

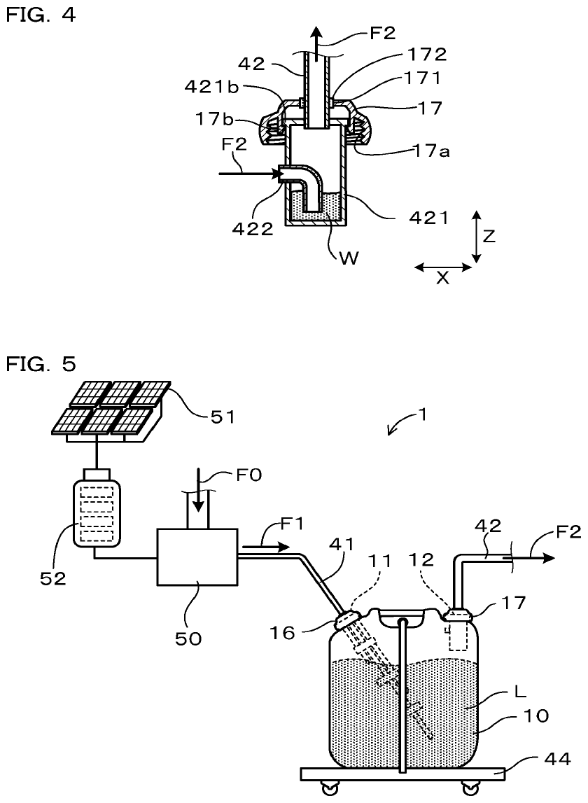

As illustrated in FIG. 1, the second opening portion 12 is covered by a second lid member 17. As illustrated in FIG. 4, the second lid member 17 has a threaded portion 17a inside that has a groove that follows the shape of a threaded portion 12a of the second opening portion 12. Similarly to the first lid member 16, by placing the second lid member 17 over the second opening portion 12 and turning the second lid member 17, the threaded portions 12a and 17a of the two are screwed to each other, and the second lid member 17 is attached so as to be detachably attachable to the reaction tank 10.

As illustrated in FIG. 1 and FIG. 4, the second lid member 17 is provided with the CO₂-removed gas discharge unit 42. The CO₂-removed gas discharge unit 42 extends outward from the reaction tank 10 through a through hole 171 formed in the second lid member 17. Note that the CO₂-removed gas discharge unit 42 is loosely fitted into the through hole 171, and the CO₂-removed gas discharge unit 42 is not fixed to the second lid member 17. Accordingly, even when the second lid member 17 is rotated when attaching the second lid member 17 to the second opening portion 12, the CO₂-removed gas discharge unit 42 can be kept from rotating. Note that a bush 172 that is cylindrical is provided in the through hole 171, and airtightness between the CO₂-removed gas discharge unit 42 and the second lid member 17 is maintained.

In the present embodiment, as illustrated in FIG. 4, a trapper 421 is provided on the reaction tank 10 side of the second lid member 17. An engaging claw 17b is provided on the reaction tank 10 side of the second lid member 17, and by a protrusion 421b provided on a circumferential face of an upper end of the trapper 421 being engaged with the engaging claw 17b, the trapper 421 is attached to the second lid member 17 in a loosely fitted state. Accordingly, even when the second lid member 17 is rotated when attaching the second lid member 17 to the second opening portion 12, the trapper 421 can be kept from rotating.

As illustrated in FIG. 4, the trapper 421 has a gas intake portion 422 that takes in gas in the reaction tank 10. Gas taken in by the gas intake portion 422 is discharged into water W held in the trapper 421. Thus, the trapper 421 can collect water-soluble harmful substances that may exist in the gas. The gas that has passed through the trapper 421 is then discharged from the CO₂-removed gas discharge unit 42.

In the reaction tank 10, CO₂ gas is brought into contact with the aqueous alkali metal hydroxide solution or aqueous alkaline earth metal hydroxide solution that is the aqueous solution introduced into the reaction tank 10, by bubbling. Examples of the aqueous solution include NaOH, KOH, Ca (OH)₂, Mg (OH)₂, and so forth. In the present embodiment, a NaOH aqueous solution is used as the aqueous solution L introduced into the reaction tank 10.

Note that in the present specification, “CO₂ gas” refers to a gas containing CO₂ as a constituent component. This CO₂ gas may be a gas containing just CO₂ as a constituent component, or may also contain unavoidable impurities. Also, the CO₂ gas may be a mixed gas containing CO₂ and other substances as constituent components. The proportion of CO₂ in the mixed gas is not limited, and the main component having the largest proportion in the mixed gas may be CO₂, or may be a substance other than CO₂.

In the present embodiment, the reactions of Formula 1 and Formula 2 below are performed in the reaction tank 10 by supplying CO₂ gas.

2NaOH+CO₂→Na₂CO₃+H₂O (Formula 1)

Na2CO3+CO₂+H₂O→2NaHCO₃ (Formula 2)

The reaction yields NaHCO₃, Na₂CO₃, and a mixture of NaHCO₃ and Na₂CO₃, as products. Note that the product is generated in an aqueous solution state in the reaction tank 10, and thereafter can be recovered in a solid state by dehydration and drying. The recovered product can be used as a resource.

Next, operational effects of the CO₂ recovery device 1 according to the present embodiment will be described below in detail.

In the CO₂ recovery device 1 according to the present embodiment, the CO₂ gas supply unit 41 and the CO₂-removed gas discharge unit 42 are attached so as to be detachably attachable to the reaction tank 10. Accordingly, the reaction tank 10 can be moved or detached as necessary when retrieving the product or introducing the reaction liquid. Thus, the trouble to retrieve the product and to introduce the reaction liquid can be reduced.

Further, in the present embodiment, the reaction tank 10 has the first opening portion 11 and the second opening portion 12. The CO₂ gas supply unit 41 is provided to the first lid member 16 that is provided so as to be detachably attachable to the first opening 11, and the CO₂-removed gas discharge unit 42 is provided to the second lid member 17 that is provided so as to be detachably attachable to the second opening portion 12. Accordingly, the CO₂ gas supply unit 41 and the CO₂-removed gas discharge unit 42 can be attached so as to be detachably attachable to the reaction tank 10 with a simple configuration.

Further, in the present embodiment, the reaction tank 10 is configured to be replaceable with respect to the first lid member 16 and the second lid member 17. Thus, after the product is generated, the reaction tank 10 can be detached from the first lid member 16 and the second lid member 17, and another reaction tank 10 into which new reaction liquid is introduced can be attached to the first lid member 16 and the second lid member 17, whereby work efficiency of retrieving the product and introducing the reaction solution can be improved.

As described above, according to the present embodiment, a CO₂ recovery device can be provided that can reduce the trouble of retrieving the product and introducing the reaction liquid.

### (Embodiment 2)

In Embodiment 1 described above, CO₂ gas is discharged into the reaction tank 10 by the pressure of the CO₂ gas flowing through the duct connected to the CO₂ gas supply unit 41, but instead of this, the CO₂ recovery device 1 according to Embodiment 2 includes a pump 50 for transporting CO₂ gas to the CO₂ gas supply unit 41, as illustrated in FIG. 5. Furthermore, in the present embodiment, the CO₂ recovery device 1 includes a solar panel system 51 that generates electric power to drive the pump 50, and a power storage device 52 that stores the electric power generated by the solar panel system 51. The pump 50 is of a power-conservation type, and can be started and driven using electric power of a level that the solar panel system 51 can generate. In FIG. 5, the pump 50 takes in and pressurizes atmosphere (air) as indicated by arrow FO, and supplies the pressurized atmosphere as CO₂ gas to the reaction tank 10 via the CO₂ gas supply unit 41 as indicated by arrow F1. Note that in Embodiment 2, components that are the same as those in Embodiment 1 are denoted by the same signs, and description thereof will be omitted.

In the second embodiment, the pump 50 can supply the pressurized atmosphere to the reaction tank 10, and accordingly CO₂ can be efficiently taken in even from the atmosphere with a low CO₂ concentration. The pump 50 is a power-conservation type and is driven by the electric power generated by the solar panel system 51, and accordingly the pump 50 does not emit CO₂ when being driven, or the amount of CO₂ that is emitted can be reduced. This can contribute to reducing CO₂ emissions for the entire device. Embodiment 2 also provides the same operational effects as Embodiment 1. Note that when the voltage of the electric power generated by the solar panel system 51 is insufficient when driving the pump 50, a booster may be provided upstream of the pump 50.

### (Embodiment 3)

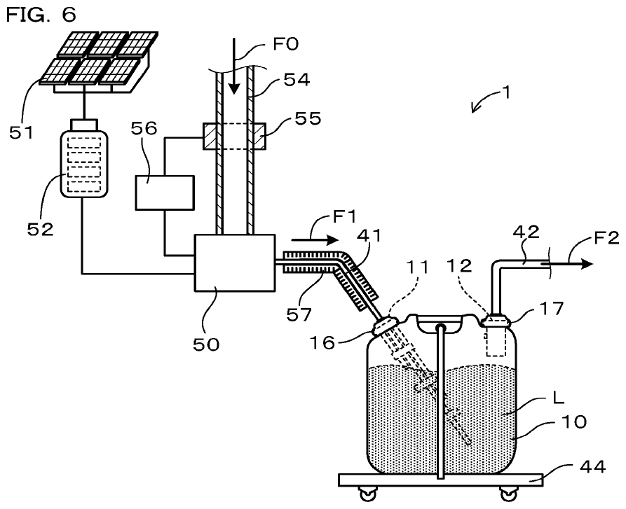

As illustrated in FIG. 6, the CO₂ recovery device 1 according to Embodiment 3 includes a pump 50 that transports CO₂ gas to the CO₂ gas supply unit 41, a thermoelectric element 55 that is provided to a duct 54 through which the CO₂ gas flows and that converts heat of the CO₂ gas into electric power, and a control unit 56 that controls driving of the pump 50 using the electric power generated by the thermoelectric element 55. Note that in Embodiment 3, components that are the same as those in preceding Embodiments are denoted by the same signs, and description thereof will be omitted.

In Embodiment 3, high temperature exhaust gas flows through the duct 54. As illustrated in FIG. 6, the thermoelectric element 55 is attached to an outer surface of the duct 54. The form of the thermoelectric element 55 is not limited in particular, and may be made of a Peltier device, for example. The control unit 56 is configured to transmit the electric power converted from the heat of the duct 54 by the thermoelectric element 55 to the pump 50, as a drive signal to start driving the pump 50. In Embodiment 3, the pump 50 is configured to start driving when receiving the drive signal, and stop driving in a state in which the drive signal is not received. Note that the electric power consumed by the pump 50 for transporting the CO₂ gas is supplied by the solar panel system 51.

According to Embodiment 3, the thermoelectric element 55 converts the thermal energy of the exhaust gas flowing through the duct 54 into electric power, which can be used as the drive signal for driving the pump 50. This can reduce the electric power consumption for drive control of the pump 50, which in turn can contribute to reducing CO2 emissions.

Further, in a state in which high temperature exhaust gas is not flowing through the duct 54, the duct 54 does not reach a high temperature, and accordingly electric power cannot be obtained from the thermoelectric element 55, and no drive signal is transmitted. Thus, the exhaust gas is not flowing in this state, and there is no need to drive the pump 50, and accordingly wasteful consumption of electric power for driving the pump 50 is suppressed.

In the CO₂ recovery device 1 according to Embodiment 3, as illustrated in FIG. 6, the pump 50 takes in and pressurizes exhaust gas flowing through the duct 54, and performs supply thereof to the reaction tank 10 as CO₂ gas, via the CO₂ gas supply unit 41.

Now, when high-temperature exhaust gas is brought into contact with the NaOH aqueous solution in the reaction tank 10, there is concern that the temperature of the NaOH aqueous solution will rise excessively, causing the water in the aqueous solution to vaporize and generate water vapor, and the NaOH aqueous solution may be released into the environment along with the water vapor. Further, when the product is NaHCO₃, upon high-temperature CO₂ gas being supplied to the reaction tank 10, there is concern that NaHCO₃ will be decomposed by the heat of the CO₂, and CO₂ will be released. Accordingly, the CO₂ gas supplied to the reaction tank 10 is preferably not at a high temperature, for example, preferably 80° C. or lower. In Embodiment 3, the temperature of the CO₂ gas supplied to the reaction tank 10 is lowered by a heat dissipation member 57 provided in the CO₂ gas supply unit 41, and the temperature of the CO₂ gas is reduced to no higher than 80° C. The configuration of the heat dissipation member 57 is not limited in particular, and may be made up of a plurality of heat dissipation fins, or by applying a heat dissipation paint to an outer surface of the CO₂ gas supply unit 41. Also, the CO₂ gas supply unit 41 itself may have a function as the heat dissipation member 57, by making the shape of the CO₂ gas supply unit 41 itself to have a shape with a large surface area. Embodiment 3 also provides the same operational effects as those in Embodiments 1 and 2.

### (Embodiment 4)

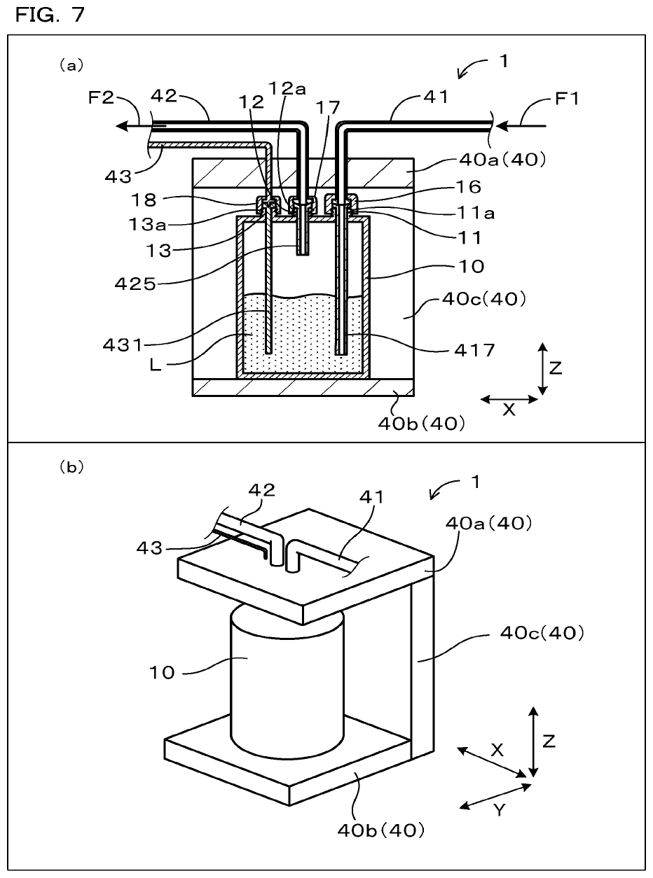

In Embodiments 1 to 3 described above, a commercially-available general-purpose polyethylene tank is used as the reaction tank 10, and also the first lid member 16 thereof is provided with the CO₂ gas supply unit 41, and the second lid member 17 thereof is provided with the CO₂-removed gas discharge unit 42. Instead of this, in Embodiment 4, as illustrated in FIG. 7(a) and FIG. 7(b), a hollow cylindrical specialized container is used as the reaction tank 10. In the configuration in Embodiment 4, components that are the same as those in

Embodiments 1 and 2 are denoted by the same signs, and description thereof will be omitted.

As illustrated in FIG. 7(a) and FIG. 7(b), in Embodiment 4, the CO₂ recovery device 1 has a main body 40. The main body 40 has a side portion 40c erected upright in the vertical direction Z, an upper portion 40a positioned above the side portion 40c, and a lower portion 40b positioned below the side portion 40c, and accordingly is configured having a generally open-box shape. The CO₂ gas supply unit 41, the CO₂-removed gas discharge unit 42, and a sensor 43 are attached to the upper portion 40a. The reaction tank 10 is placed on the lower portion 40b.

As illustrated in FIG. 7(a) and FIG. 7(b), the reaction tank 10 has a hollow cylindrical shape. In the present embodiment, an outer surface of the reaction tank 10 is black.

Note that in FIG. 7(b), the width direction is X, the front-rear direction is Y, and the vertical direction is Z. In the present embodiment, the upper portion 40a of the main body 40 is slidable in the vertical direction Z, and also the lower portion 40b of the main body 40 is slidable in the front-rear direction Y, so that the reaction tank 10 is easily detachably attachable to the main body 40.

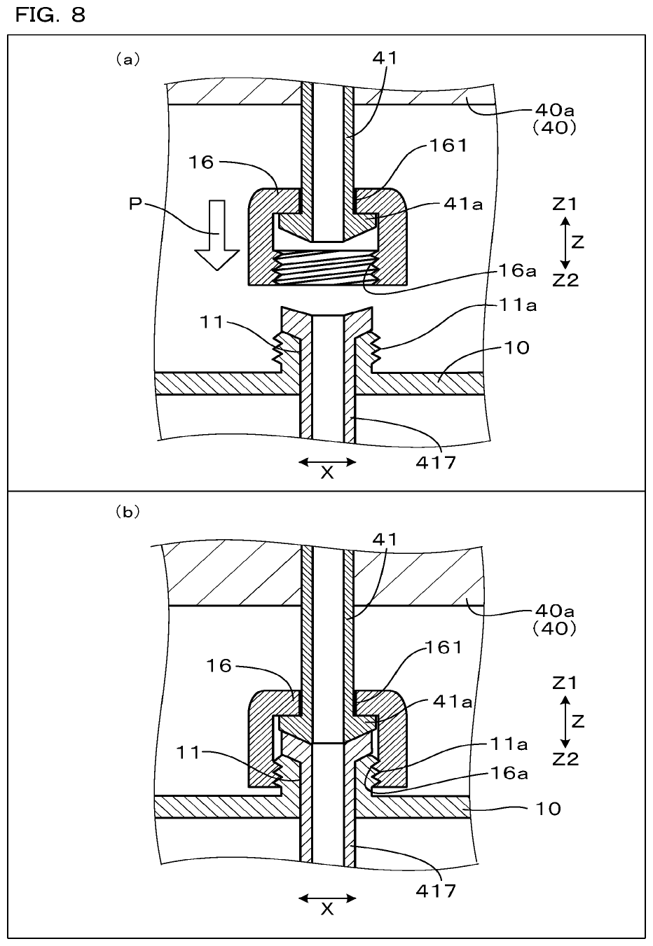

In the present embodiment, as illustrated in FIG. 7(a), the first opening portion 11, the second opening portion 12, and a third opening portion 13 are formed on the upper face of the reaction tank 10. As illustrated in FIGS. 7(a), 8(a), and 8(b), a gas supply nozzle portion 417 forming a distal end of the CO₂ gas supply unit 41 is inserted into the first opening portion 11, and the gas supply nozzle portion 417 is fixed to an upper portion of the reaction tank 10. The threaded portion 11a, in which a groove is formed, is provided on the outer peripheral face of the cylindrical portion forming the first opening portion 11.

As illustrated in FIG. 7(a), a gas discharge nozzle portion 425 forming a distal end of the CO₂-removed gas discharge unit 42 is inserted into the second opening portion 12, and the gas discharge nozzle portion 425 is fixed to the upper portion of the reaction tank 10. The threaded portion 12a, in which a groove is formed, is provided on the outer peripheral face of the cylindrical portion forming the second opening portion 12.

As illustrated in FIG. 7(a), a sensor distal end portion 431 forming a distal end of the sensor 43 for detecting the state of the aqueous solution L is inserted into the third opening portion 13, and the sensor distal end portion 431 is fixed to the upper portion of the reaction tank 10. A threaded portion 13a, in which a groove is formed, is provided on an outer peripheral face of a cylindrical portion forming the third opening portion 13.

As illustrated in FIG. 7(a), the first opening portion 11 is covered by the first lid member 16. As illustrated in FIG. 8 (a), the threaded portion 16a having a groove that follows the shape of the threaded portion 11a of the first opening portion 11 is formed on an inner peripheral face of the first lid member 16. By placing the first lid member 16 over the first opening portion 11 and turning the first lid member 16, the threaded portions 11ₐ and 16a of the two are screwed to each other, and the first lid member 16 is attached so as to be detachably attachable to the reaction tank 10, as illustrated in FIG. 8 (b).

As illustrated in FIG. 7 (a), the first lid member 16 is provided with the CO2 gas supply unit 41. As illustrated in FIG. 8 (a), the CO₂ gas supply unit 41 is inserted into the through hole 161 formed in the first lid member 16 in a loosely fitted state, and extends outward from the reaction tank 10. An enlarged-diameter portion 41a is formed at the distal end of the CO₂ gas supply unit 41, and the CO₂ gas supply unit 41 is prevented from coming out from the first lid member 16. Thus, when attaching the first lid member 16 to the first opening portion 11, even though the upper portion 40a of the main body 40, which had been moved upward Z1 in the vertical direction, is moved downward Z2 in the vertical direction as indicated by arrow P, and the first lid member 16 is placed over the first opening portion 11 and turned, the CO₂ gas supply unit 41 is configured not to rotate.

Although omitted from illustration, the second lid member 17 is attached so as to be detachably attachable to the second opening portion 12, similar to the first opening portion 11 and the first lid member 16. Accordingly, the CO₂-removed gas discharge unit 42 and the gas discharge nozzle portion 425 are connected. Also, the third lid member 18 is attached so as to be detachably attachable to the third opening portion 13, similar to the first opening portion 11 and the first lid member 16. Accordingly, the sensor 43 and the sensor distal end portion 431 are connected. Note that when there is no need to provide the sensor 43, a configuration may be made that does not have the sensor 43, the sensor distal end portion 431, the third opening portion 13, and the third lid member 18.

Embodiment 4 includes the main body 40 to which the CO₂ gas supply unit 41 and the CO₂-removed gas discharge unit 42 are attached, and the reaction tank 10 is provided so as to be detachably attachable to the main body 40. Thus, even when a specialized container is used as the reaction tank 10, moving or detaching the reaction tank as necessary when retrieving a product or introducing reaction liquid is facilitated, and 10 accordingly trouble of retrieving the product and introducing the reaction liquid can be reduced.

Also, in Embodiment 4, the CO₂ gas supply unit 41, the CO₂-removed gas discharge unit 42, and the sensor 43, which are fixed to the main body 40, are individually provided so as to be detachably attachable to the reaction tank 10, via the first lid member 16, the second lid member 17, and the third lid member 18. By detaching the first lid member 16, the second lid member 17, and the third lid member 18 as necessary, when retrieving the product or introducing the reaction liquid, the reaction tank 10 can be detached from the CO2 gas supply unit 41, the CO₂-removed gas discharge unit 42, and the sensor 43, which are fixed to the main body 40. Thus, the reaction tank 10 can be a cartridge type, which can be easily attached to and detached from the main body 40, and also the reaction tank 10 can be replaced with respect to the main body 40. As a result, the trouble to retrieve the product and to introduce the reaction liquid can be reduced.

### (Embodiment 5)

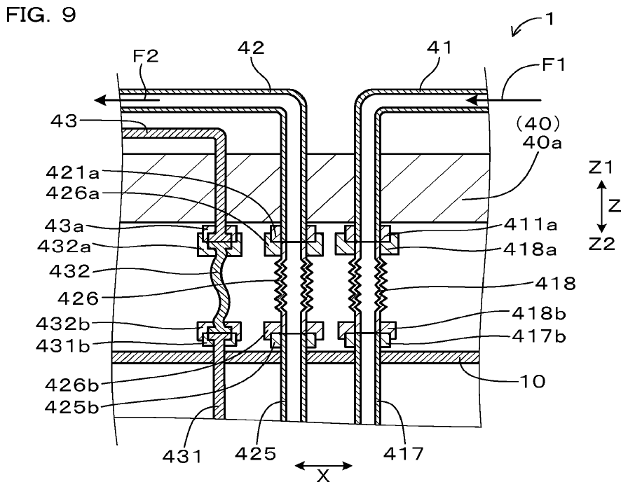

In Embodiment 4 described above, the CO₂ gas supply unit 41, the CO₂-removed gas discharge unit 42, and the sensor 43, which are fixed to the main body 40, are respectively provided so as to be detachably attachable to the gas supply nozzle portion 417, the gas discharge nozzle portion 425, and sensor distal end portion 431, provided to the reaction tank 10, via the lid members 16 to 18. Instead of this, in Embodiment 5, as illustrated in FIG. 9, the CO₂ gas supply unit 41 is connected to and communicates with the gas supply nozzle portion 417 by a relay pipe 418. The relay pipe 418 is made of ductile resin, and is a bellows-like hollow pipe. A connecting portion between the relay pipe 418 and the CO₂ gas supply unit 41 is configured to be detachably attachable by attachment/detachment mechanisms 411a and 418a that can be easily attached to and detached from each other. Similarly, a connecting portion between the relay pipe 418 and the gas supply nozzle portion 417 is also configured to be detachably attachable by attachment/detachment mechanisms 418b and 417b that can be easily attached to and detached from each other.

Further, as illustrated in FIG. 9, the CO₂-removed gas discharge unit 42 is also connected to and communicates with the gas discharge nozzle portion 425 by a relay pipe 426. The relay pipe 426 is made of ductile resin, and also is a bellows-like hollow pipe. A connecting portion between the relay pipe 426 and the CO₂ gas supply unit 41 is configured to be detachably attachable by attachment/detachment mechanisms 421a and 426a that can be easily attached to and detached from each other. Similarly, a connecting portion between the relay pipe 426 and the gas discharge nozzle portion 425 is also configured to be detachably attachable by attachment/detachment mechanisms 426b and 425b that can be easily attached to and detached from each other.

Further, as illustrated in FIG. 9, the sensor 43 is also connected to and communicates with the sensor distal end portion 431 by a sensor relay portion 432. The sensor relay portion 432 is flexible and has a length that is sufficiently longer than the distance between the sensor 43 and the sensor distal end portion 431. A connecting portion between the sensor relay portion 432 and the sensor is configured to be detachably attachable by attachment/detachment mechanisms 43a and 432a that can be easily attached to and detached from each other. Similarly, a connecting portion between the sensor relay portion 432 and the sensor distal end portion 431 is also configured to be detachably attachable by attachment/detachment mechanisms 432b and 431b that can be easily attached to and detached from each other. Note that the other configurations in Embodiment 5 are the same as those in Embodiment 4, and accordingly are denoted by the same signs as in embodiment 4, and description thereof will be omitted.

In Embodiment 5, as illustrated in FIG. 9, the CO₂ gas supply unit 41, the CO₂-removed gas discharge unit 42, and the sensor 43, which are fixed to the main body 40, are individually provided so as to be detachably attachable to the reaction tank 10 by the relay pipes 418 and 426 and the sensor relay portion 432, and accordingly attaching and detaching of the reaction tank 10 is facilitated. Embodiment 5 also provides the same operational effects as Embodiment 4.

### (Embodiment 6)

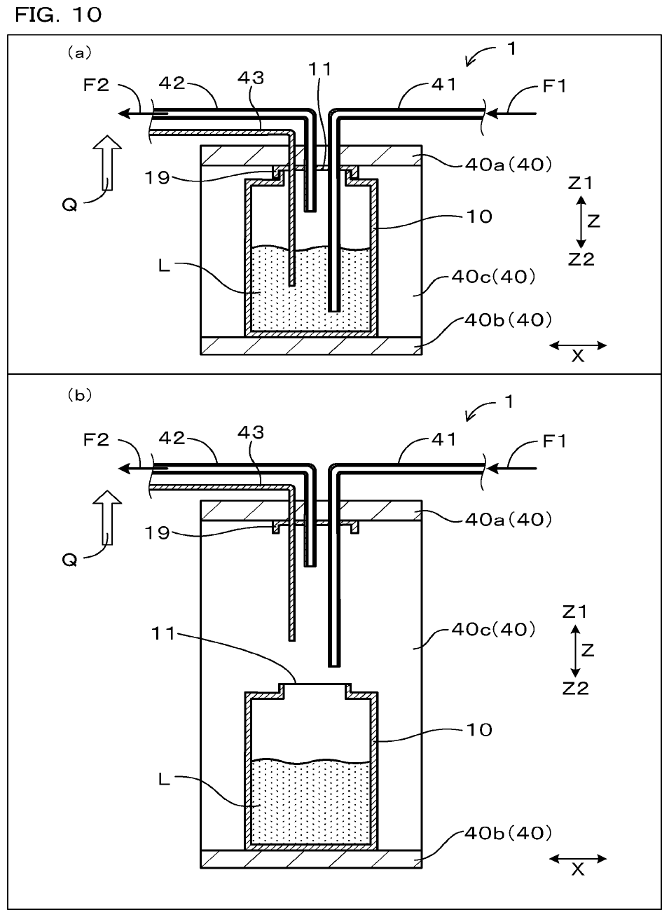

In Embodiments 4 and 5 described above, the reaction tank 10 is provided with the gas supply nozzle portion 417, the gas discharge nozzle portion 425, and the sensor distal end portion 431, and the CO₂ gas supply unit 41, the CO₂-removed gas discharge unit 42, and the sensor 43, which are fixed to the main body 40, are connected thereto, but instead of this, in Embodiment 6, the upper portion of the reaction tank 10 is an opening portion 11 that is left open, as illustrated in FIG. 10(a) and FIG. 1(b), and a lid portion 19 that covers this opening portion 11 is provided on a rear face of the upper portion 40a of the main body 40. The CO₂ gas supply unit 41, the CO₂-removed gas discharge unit 42, and the sensor 43 are in a state of being fixed to both the main body 40 and the lid portion 19, in a state of passing through the lid portion 19 as well as the main body 40. Note that FIG. 10(a) illustrates a state in which the lid portion 19 is attached to the opening portion 11 of the reaction tank 10, and FIG. 10(b) illustrates a state in which the lid portion 19 is detached from the opening portion 11 of the reaction tank 10.

As illustrated in FIG. 10(a), the CO₂ gas supply unit 41, the CO₂-removed gas discharge unit 42, and the sensor 43 are inserted into the reaction tank 10 through the opening portion 11, configured such that the distal ends of each are situated in the reaction tank 10. Then, by moving the upper portion 40a of the main body 40 upward Z1 in the vertical direction as indicated by arrow Q in FIG. 10(a), the CO₂ gas supply unit 41, the CO₂-removed gas discharge unit 42, and the sensor 43, which are fixed to the main body 40 as well as to the lid portion 19, can be detached from the reaction tank 10, as illustrated in FIG. 10(b).

As described above, Embodiment 6 is configured with the reaction tank 10 having the opening portion 11, and the CO₂ gas supply unit 41 and the CO₂-removed gas discharge unit 42 being inserted into the reaction tank 10 from the opening portion 11. The main body 40 has the lid portion 19 that covers the opening portion 11 of the reaction tank 10, and the CO₂ gas supply unit 41 and the CO₂-removed gas discharge unit 42 are attached to the lid portion 19. Accordingly, the CO₂ gas supply unit 41 and the CO₂-removed gas discharge unit 42 can be attached to and detached from the reaction tank 10, and the opening portion 11 can be closed and opened by the lid portion 19 at the same time, whereby the trouble of attaching and detaching the reaction tank 10 to and from the main body 40 can be reduced even further. Note that Embodiment 6 also provides the same operational effects as Embodiment 1.

### (Embodiment 7)

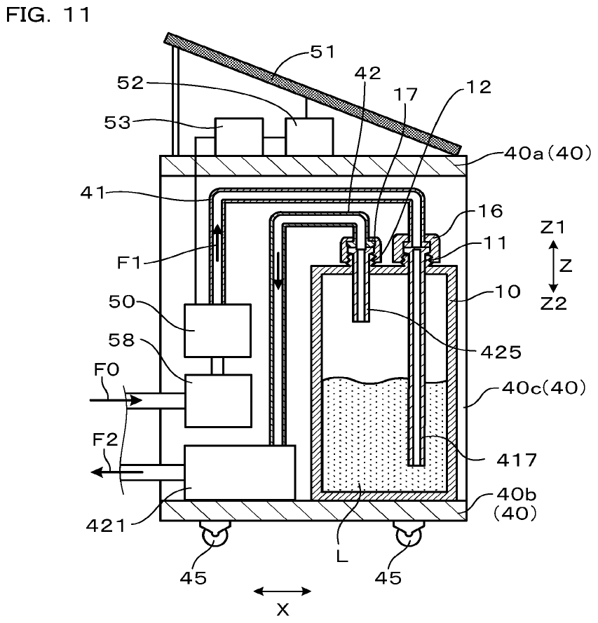

In the Embodiment 4 described above, the sensor 43 is provided as illustrated in FIG. 7(a), but instead of this, in Embodiment 7, the sensor 43 is not provided, as illustrated in FIG. 11. Instead of managing the amount of product produced by the sensor 43, in the present embodiment the amount of product produced and so forth is managed by acquiring the cumulative operating time of power generation by the solar panel system 51 or the cumulative operating time of the pump 50. For example, when the cumulative operating time reaches an amount of time that is set in advance, judgement can be made that all the NaOH in the aqueous solution L has reacted with CO₂, and the aqueous solution L in the reaction tank 10 is to be replaced. This eliminates the need for electric power to drive the sensor 43, and thus can reduce electric power consumption and further suppress CO₂ emissions. Note that the aqueous solution L can be replaced by detaching the reaction tank 10 from the main body 40.

As illustrated in FIG. 11, in Embodiment 7, the solar panel system 51 is provided on an upper face of the upper portion 40a of the main body 40. The pump 50 is configured to use, as driving electric power, electric power generated by the solar panel system 51 and stored in the power storage device 52, which is boosted by a booster 53. Note that the electric power generated by the solar panel system 51 can be used as driving electric power for the booster 53. Also, a filter 58 is provided upstream of the pump 50, to remove foreign matter from intake air indicated by F0. The configuration of the filter 58 is not limited, and a known configuration can be employed. Note that in Embodiment 7, the outer surface of the reaction tank 10 is black. In Embodiment 7, all configurations are provided in the main body 40, and are movable by the tires 45 provided on the lower portion 40b of the main body 40. In Embodiment 7, configurations that are the same as those in the preceding Embodiments are denoted by the same signs, and description thereof will be omitted.

Embodiment 7 can also provide the same operational effects as those of the preceding Embodiments.

### (Embodiment 8)

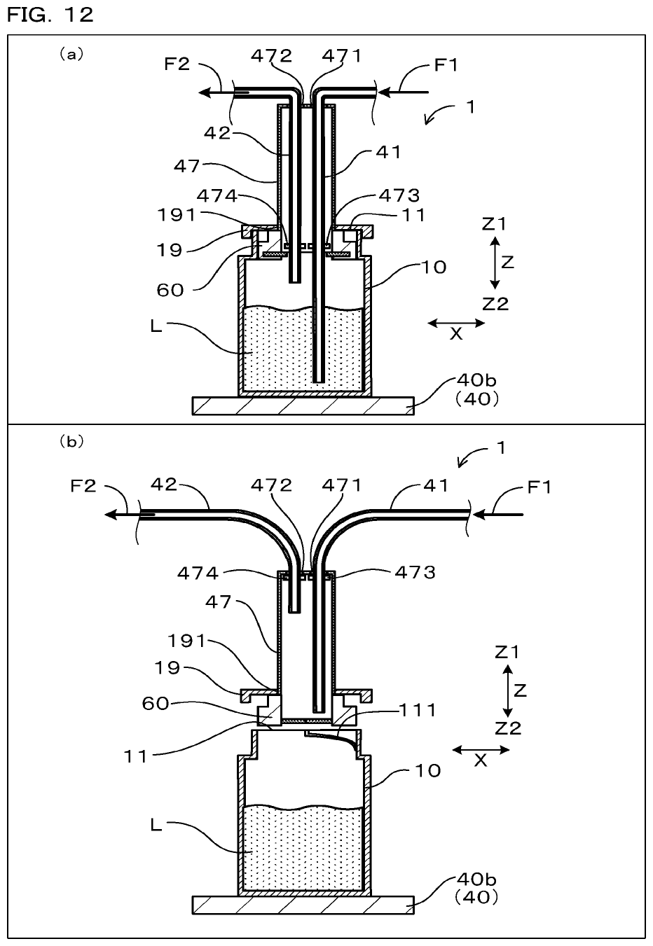

In Embodiment 6 illustrated in FIG. 10(a) and FIG. 10(b) described above, the lid portion 19 covering the opening portion 11 of the reaction tank 10 is provided on the rear face of the upper portion 40a of the main body 40, but instead of this, an arrangement may be made such as that of Embodiment 8 illustrated in FIG. 12(a) and FIG. 12 (b). FIG. 12(a) illustrates a state in which the lid portion 19 is attached to the opening portion 11 of the reaction tank 10, and FIG. 12(b) illustrates a state in which the lid portion 19 is detached from the opening 11 of the reaction tank 10. As illustrated in FIG. 12(a), the lid portion 19 is provided at a lower end of a sleeve portion 47 that is cylindrical. The lid portion 19 has an opening portion 191 into which the sleeve portion 47 is fitted. An opening/closing mechanism 60 is provided on a rear face side of the lid portion 19. As illustrated in FIG. 12(b), in the state in which the lid portion 19 is detached from the opening portion 11 of the reaction tank 10, the opening/closing mechanism 60 is in a closed state in which the distal end side of the CO₂ gas supply unit 41 is closed. On the other hand, as illustrated in FIG. 12(a), in the state in which the lid portion 19 is attached to the opening portion 11 of the reaction tank 10, the opening/closing mechanism 60 is in an open state in which the distal end side of the CO₂ gas supply unit 41 is opened. Note that in the present Embodiment, configurations that are the same as those in the preceding Embodiments are denoted by the same signs, and description thereof will be omitted.

As illustrated in FIG. 12(a) and FIG. 12(b), the sleeve portion 47 has a cylindrical shape, and through holes 471 and 472 are provided at an upper end of the sleeve portion 47. The CO₂ gas supply unit 41 and the CO₂-removed gas discharge unit 42 are inserted through the through holes 471 and 472 with slight clearances, respectively, and the CO₂ gas supply unit 41 and the CO₂-removed gas discharge unit 42 are movable in an up-down direction within the sleeve portion 47. Note that retaining protrusions 473 and 474 having outside diameters larger than those of the through holes 471 and 472 are provided on outer peripheral faces of the CO₂ gas supply unit 41 and the CO₂-removed gas discharge unit 42, respectively. The retaining protrusions 473 and 474 prevent the CO₂ gas supply unit 41 and the CO₂-removed gas discharge unit 42 from moving beyond their respective predetermined positions within the sleeve portion 47 and coming loose from the sleeve portion 47.

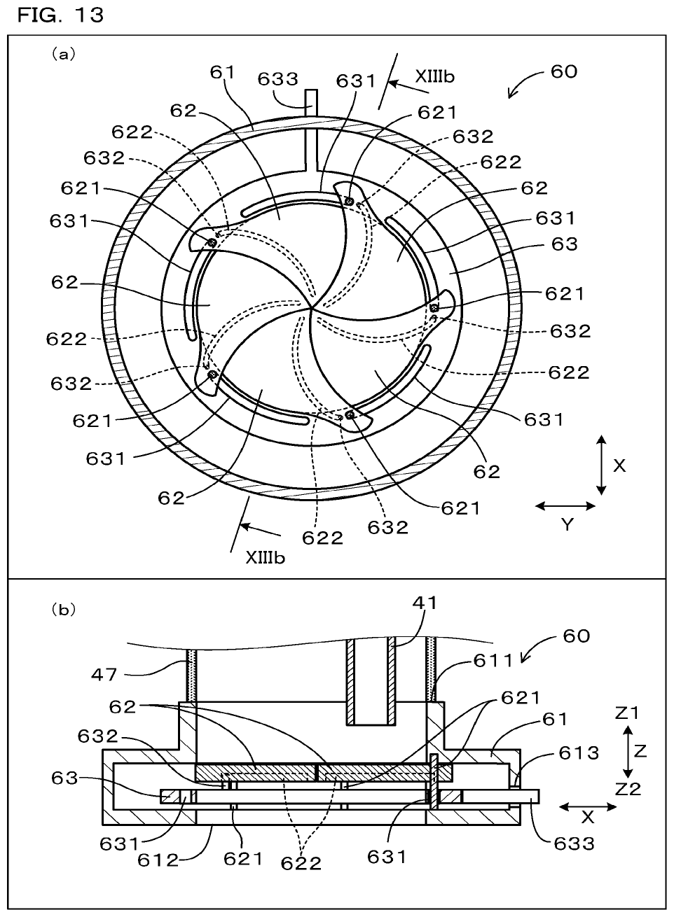

As illustrated in FIG. 13(a) and FIG. 13(b), the opening/closing mechanism 60 includes a case 61, blade members 62, and a regulating plate 63. As illustrated in FIG. 13(b), an upper portion of the case 61 is open, and an upper end portion 611 of the case 61 and the lower end of the sleeve portion 47 are connected, so as to communicate with inside of the sleeve portion 47. Also, a lower portion of the case 61 is also opened to form an opening portion 612.

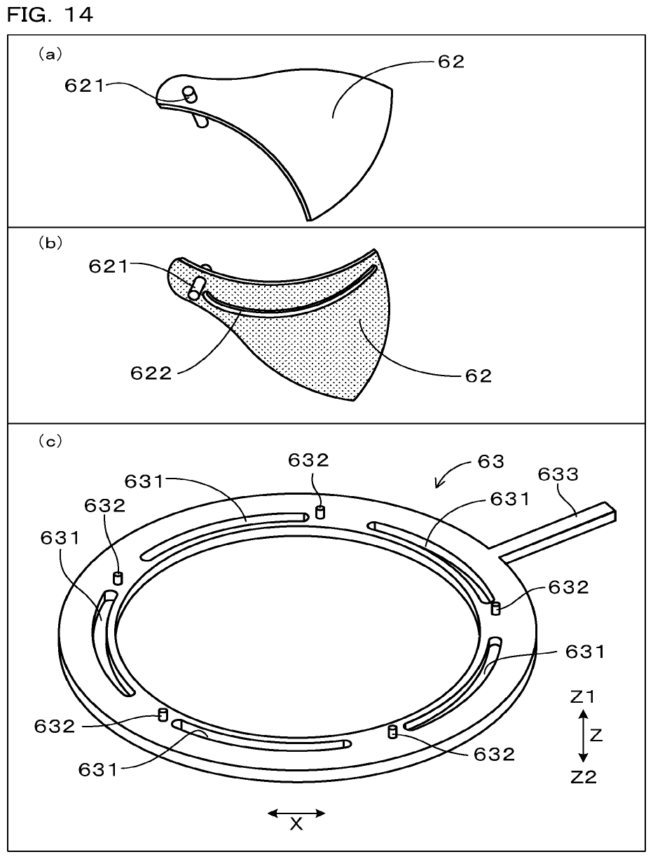

As illustrated in FIG. 13(a) and FIG. 13(b), the blade members 62 are provided inside the case 61, and in the present embodiment, five blade members 62 are provided. As illustrated in FIG. 14(a) and FIG. 14(b), each blade member 62 is a substantially fan-shaped plate member, and a pivot pin 621 is inserted through a narrow portion in plan view: As illustrated in FIG. 14(b), a groove portion 622 that is substantially arcuate is formed on a rear face of the blade member 62, extending from the narrow portion to a broad portion in plan view: As illustrated in FIG. 13(a), the five blade members 62 are disposed so that their pivot pins 621 are positioned on the same circle at equal intervals, and as illustrated in FIG. 13(b), the blade members 62 are attached to the case 61 via the pivot pins 621, and each blade member 62 is pivotable about its respective pivot pin 621.

As illustrated in FIG. 13(b), the regulating plate 63 is provided downward from the blade members 62. As illustrated in FIG. 14(c), the regulating plate 63 is a substantially ring-shaped plate member. Arcuate through portions 631 are formed in the regulating plate 63, passing therethrough in arcuate shapes along an inner peripheral face thereof. Five circular arcuate through portions 631 are formed, and are positioned on the same circle at equal intervals. Regulating pins 632 are provided between adjacent arcuate through portions 631. The regulating pins 632 protrude upward Z1 in the vertical direction, i.e., toward the blade members 62 side. A total of five regulating pins 632 are provided. The regulating plate 63 has an outward protruding portion 633 that protrudes outward on an outer edge thereof in a radial direction. As illustrated in FIG. 13(a) and FIG. 13(b), in the regulating plate 63, the pivot pins 621 of the five blade members 62 are inserted into the respective arcuate through portions 631 downward Z2 in the vertical direction of the blade members 62, and also the regulating pins 632 are respectively provided to fit into the groove portions 622 of the five blade members 62. Also, as illustrated in FIG. 13(b), the outward protruding portion 633 of the regulating plate 63 is inserted into a slit 613 provided in a side wall of the case 61, and protrudes outward from the case 61. Note that the slit 613 is formed over a predetermined range in a circumferential direction.

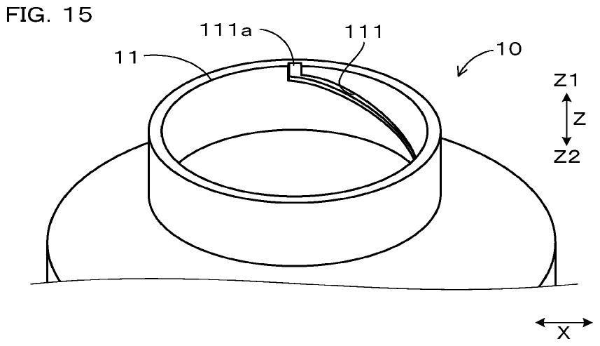

On the other hand, as illustrated in FIG. 15, an inner groove portion 111 is provided on an inner peripheral face of the cylindrical portion forming the opening portion 11 of the reaction tank 10. The inner groove portion 111 continues downward Z2 in the vertical direction along the circumferential direction. The size of the inner groove portion 111 is such that the outward protruding portion 633 of the above regulating plate 63 can be inserted therein with a slight clearance.

Next, description will be made regarding a form of movement of the blade members 62, when transitioning from the state in which the lid portion 19 and the opening/closing mechanism 60 are detached from the reaction tank 10 as illustrated in FIG. 12 (b), to the state in which the lid portion 19 and the opening/closing mechanism 60 are attached to the reaction tank 10 as illustrated in FIG. 12(a).

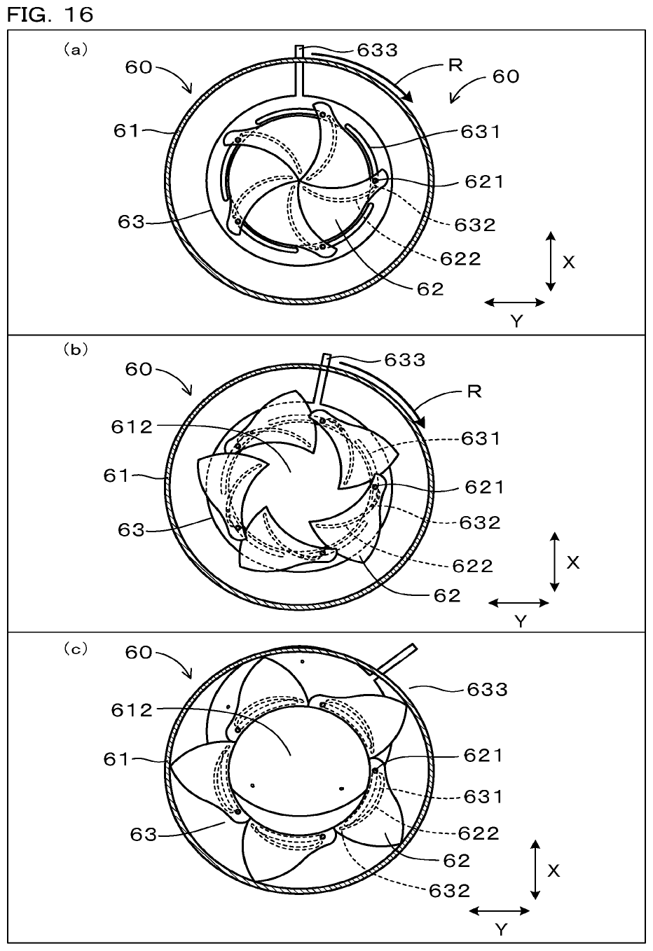

First, as illustrated in FIG. 16 (a), in an initial state in which the lid portion 19 and the opening/closing mechanism 60 are detached from the reaction tank 10, the regulating pins 632 of the regulating plate 63 are positioned in the groove portions 622 of the blade members 62, at end portions thereof on a side closer to the pivot pins 621, and the pivot pins 621 of the blade members 62 are positioned at end portions on one side within the arcuate through portions 631 of the regulating plate 63. In this initial state, the five blade members 62 cover the opening portion 612 at a lower end of the case 61 that is illustrated in FIG. 13 (b), in a state of completely closing off the opening portion 612.

In a state in which an upper end 111a of the inner groove portion 111 illustrated in FIG. 15 is aligned with the outward protruding portion 633 of the regulating plate 63 illustrated in FIG. 13(a), the opening/closing mechanism 60 is inserted into the opening portion 11 of the reaction tank 10. Thus, the outward protruding portion 633 moves in the circumferential direction along the inner groove portion 111. That is to say, as illustrated in FIG. 16(b), the outward protruding portion 633 moves in a direction of arrow R, and the regulating plate 63 turns in the direction of arrow R. Thus, the regulating pins 632 of the regulating plate 63 move toward end portions of the groove portions 622 of the blade members 62 on a far side from the pivot pins 621, so that each of the blade members 62 pivot outward about the pivot pins 621. Accordingly, the opening portion 612 that was in a closed state gradually transitions to an opened state. Note that the pivot pins 621 of the blade members 62 are observed to move relatively toward end portions on the other side within the arcuate through portions 631 as the regulating plate 63 turns.

Thereafter, as illustrated in FIG. 16(c), when the regulating plate 63 further turns in the direction of arrow R and the pivot pins 621 of the blade members 62 are positioned at the end portions on the other side of the arcuate through portions 631, the regulating pins 632 of the regulating plate 63 are located at the end portions of the groove portions 622 of the blade members 62 on the far side from the pivot pins 621. Thus, the blade members 62 further pivot outward about the pivot pins 621, and the opening portion 612 is completely opened, leaving the distal end side of the CO₂ gas supply unit 41 in an opened state. Thereafter, as illustrated in FIG. 12(a), the CO₂ gas supply unit 41 and the CO₂-removed gas discharge unit 42 are lowered into the reaction tank 10, thereby completing the attachment of the lid portion 19.

When detaching the lid portion 19, the procedures described above are reversed. That is to say, first, as illustrated in FIG. 16(c), in a state in which the blade members 62 have the opening portion 612 completely opened, the CO₂ gas supply unit 41 and the CO₂-removed gas discharge unit 42 are raised from inside the reaction tank 10 to within the sleeve portion 47. Thereafter, by raising the opening/closing mechanism 60, the opening portion 612 which was in the open state gradually transitions to the state of being closed by the five blade members 62 as illustrated in FIG. 16(b). Then, as illustrated in FIG. 16(a), after the opening portion 612 is completely closed and the distal end side of the CO2 gas supply unit 41 is covered, the lid portion 19 and the opening/closing mechanism 60 are detached from the reaction tank 10.

As described above, the opening/closing mechanism 60 forms an aperture in the opening portion 612 using the five blade members 62, and controls the opening/closing state of the opening portion 612. Note that opening and closing of the opening portion 612 can also be manually controlled by manually moving the outward protruding portion 633 in the direction of arrow R or in the opposite direction, to open or close the blade members 62. Note that in the present embodiment, the regulating plate 63 is biased in the opposite direction of arrow R by a biasing member that is omitted from illustration, so that the initial state illustrated in FIG. 16(a), of the state of the lid portion 19 and the opening/closing mechanism 60 being detached from the reaction tank 10, is maintained.

According to Embodiment 8, the distal end side of the CO₂ gas supply unit 41 is provided with the opening/closing mechanism 60 that covers the distal end side of the CO₂ gas supply unit 41 so as to be in the closed state when the lid portion 19 is detached from the opening portion 11, and opens the distal end side of the CO₂ gas supply unit 41 to be in the open state when the lid portion 19 is attached to the opening portion 11. Thus, even when some aqueous solution L adhering to the distal end of the CO₂ gas supply unit 41 drops as water droplets when the CO₂ gas supply unit 41 is detached from the reaction tank 10, the opening/closing mechanism 60 remains in the closed state, and accordingly the fallen water droplets remain within the opening/closing mechanism 60 and can be prevented from leaking to the outside. The water droplets remaining in the opening/closing mechanism 60 can be dropped into the reaction tank 10 when the opening/closing mechanism 60 is in the open state when the CO₂ gas supply unit 41 is reattached, and accordingly external leakage of the droplets can be prevented. Note that the water droplets remaining in the opening/closing mechanism 60 may be detached as appropriate by manually placing the opening/closing mechanism 60 in an open state. The present embodiment also provides the same operational effects as the preceding embodiments.

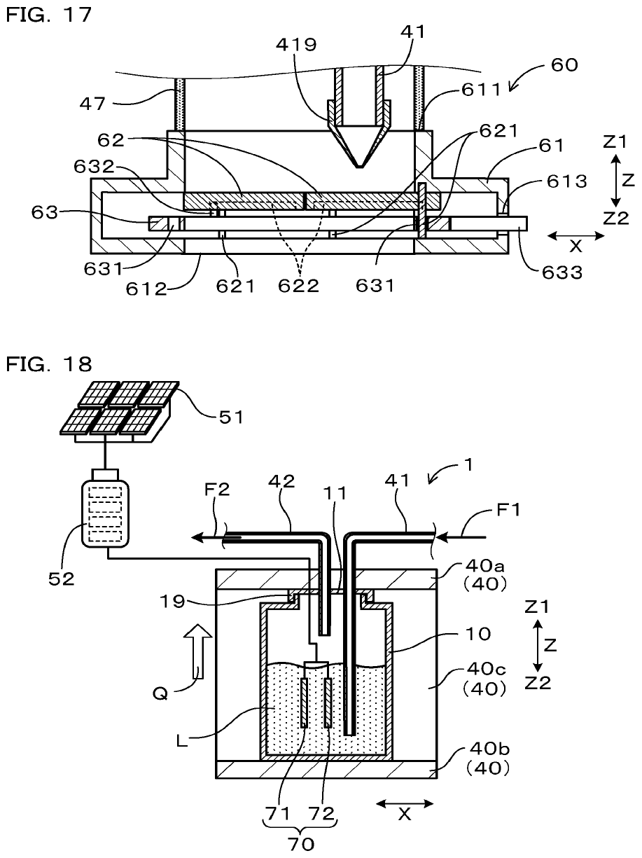

Note that a nozzle head 419 for bubbling may be attached to the distal end of the CO₂ gas supply unit 41 as in a modification illustrated in FIG. 17. In this case, as illustrated in FIG. 17, the opening/closing mechanism 60 may be closed by raising the CO₂ gas supply unit 41 in a state in which the nozzle head 419 is attached.

### (Embodiment 9)

In Embodiment 9, an electrolysis device 70 is provided as illustrated in FIG. 18, in place of the sensor 43 in the configuration of Embodiment 6 above in FIG. 10. Note that in

Embodiment 9, configurations that are the same as those in Embodiment 6 above are denoted by the same signs, and description thereof will be omitted.

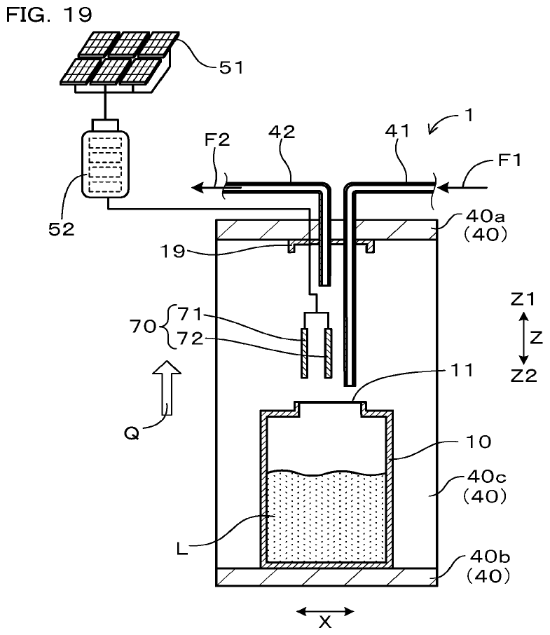

In the present Embodiment 9, as illustrated in FIG. 18, the electrolysis device 70 includes electrodes 71 and 72. The electrodes 71 and 72 are immersed in the aqueous solution L in the reaction tank 10. The electrodes 71 and 72 are configured to be supplied with electric power that is generated by the solar panel system 51 and stored in the power storage device 52. The electrodes 71 and 72 are fixed to the lid portion 19 and the upper portion 40a of the main body 40 via a support portion that is omitted from illustration. Also, as illustrated in FIG. 19, moving the upper portion 40a of the main body 40 upward Z1 in the vertical direction as indicated by arrow Q enables the electrodes 71 and 72 to be detached from the reaction tank 10 together with the CO₂ gas supply unit 41 and the CO₂-removed gas discharge unit 42 that are fixed to the lid portion 19 and the main body 40. Thus, the electrodes 71 and 72 detachably attachable to the reaction tank 10. Note that the material of the reaction tank 10 is alkali-resistant, and is not limited in particular, but may be made of stainless steel or may be made of metal with surface treatment such as a resin lining or the like.

In the present Embodiment 9, in the initial state, an NaCl aqueous solution is stored as the aqueous solution L in the reaction tank 10. Applying electricity to the electrodes 71 and 72 enables a reaction expressed by the following Formula 3 to proceed by electrolysis.

2NaCl+H₂O→2NaOH+Cl₂+H₂ (Formula 3)

Thus, a NaOH aqueous solution can be generated in the reaction tank 10. Note that the Cl₂gas and the H2 gas generated in the reaction can be retrieved from the reaction tank 10 via the CO₂-removed gas discharge unit 42, and collected with a predetermined filter or the like. Note that a diaphragm such as an ion exchange membrane may be provided between the electrode 71 and the electrode 72. Providing this partition facilitates separation of the Cl₂ gas and the H2 gas generated in the above reaction, and also enables stable retrieval of NaOH.

Although the concentration of the NaCl aqueous solution introduced into the reaction tank 10 is not limited, using a high-concentration NaCl aqueous solution of 5% or higher enables a highly-concentrated NaOH aqueous solution to be obtained, and CO₂recovery efficiency can be improved. Note that in a case in which the voltage output from the solar panel system 51 and the power storage device 52 is lower than the voltage required for electrolysis, a booster can be used to boost the voltage to the required voltage, and thereby perform electrolysis.

NaOH aqueous solution has strong alkalinity, and high-concentration NaOH aqueous solution requires special care in handling, but NaCl aqueous solution is neutral and easy to handle. Thus, according to the configuration of the present Embodiment 9, NaCl aqueous solution may be introduced into the reaction tank 10 instead of the NaOH aqueous solution, thereby improving work efficiency.

In the present Embodiment 9, the solar panel system 51 is used as a solar power generation device that generates electric power from sunlight and supplies electric power to the electrolysis device 70. Accordingly, the electrolysis device 70 does not emit CO₂ when being driven, or the amount of CO₂ that is emitted can be reduced. This can contribute to reducing CO₂ emissions for the entire device.

In the present Embodiment 9, the electrolysis device 70 includes the electrodes 71 and 72 that are provided so as to be detachably attachable to the reaction tank 10. Accordingly, this facilitates moving or detaching of the reaction tank 10 as necessary, when retrieving the product or introducing the reaction liquid. Thus, the trouble to retrieve the product and to introduce the reaction liquid can be reduced. The present Embodiment 9 also provides the same operational effects as Embodiment 6.

Although the present disclosure has been described based on the embodiments, it should be understood that the present disclosure is not limited to such embodiments or structures. The present disclosure includes various modified forms and modifications within a scope of equivalency. In addition, various combinations and forms, and further other combinations and forms including these and just one element, or more elements, or fewer elements, are also within the spirit and scope of the present disclosure. For example, the opening/closing mechanism 60 in Embodiment 8 and the electrolysis device 70 in Embodiment 9 may be applied to Embodiments 1 to 7.

1-9. (canceled)

10. A CO₂ recovery device (1), comprising:
a reaction tank in which CO₂ gas is brought into contact with an aqueous alkali metal hydroxide solution or an aqueous alkaline earth metal hydroxide solution;
a CO₂ gas supply unit that supplies the CO₂ gas into the reaction tank; and
a CO₂-removed gas discharge unit that discharges CO₂-removed gas, from which CO2 has been removed, from the reaction tank, wherein the CO₂ gas supply unit and the CO₂-removed gas discharge unit are attached so as to be detachably attachable to the reaction tank.

11. The CO₂ recovery device according to claim 10, wherein
the reaction tank has a first opening portion and a second opening portion,
the CO₂ gas supply unit is provided in a first lid member that is provided so as to be detachably attachable in the first opening portion, and
the CO₂-removed gas discharge unit is provided in a second lid member that is provided so as to be detachably attachable in the second opening portion.

12. The CO₂ recovery device according to claim 11, wherein the reaction tank is configured to be replaceable with respect to the first lid member and the second lid member.

13. The CO₂ recovery device according to claim 10, further comprising a main body to which the CO₂ gas supply unit and the CO₂-removed gas discharge unit are attached, wherein the reaction tank is provided so as to be detachably attachable to the main body.

14. The CO₂ recovery device according to claim 13, wherein
the reaction tank has an opening portion,
the CO₂ gas supply unit and the CO₂-removed gas discharge unit are configured to be inserted into the reaction tank from the opening portion, and
the main body has a lid portion that covers the opening portion of the reaction tank, and the CO₂ gas supply unit and the CO₂-removed gas discharge unit are attached to the lid portion.

15. The CO₂ recovery device according to claim 10, wherein a distal end side of the CO₂ gas supply unit is provided with an opening/closing mechanism that covers the distal end side of the CO₂ gas supply unit so as to be in a closed state when the CO₂ gas supply unit is detached from the reaction tank, and that opens the distal end side of the CO₂ gas supply unit so as to be in an open state when the CO₂ gas supply unit is attached to the reaction tank.

16. The CO₂ recovery device according to claim 10, further comprising:
a pump that transports the CO₂ gas to the CO₂ gas supply unit;
a thermoelectric element that is provided in a duct through which the CO₂ gas flows, and that converts heat of the CO₂ gas into electric power; and
a control unit that controls driving of the pump by the electric power generated by the thermoelectric element.

17. The CO₂ recovery device according to claim 10, further comprising:
an electrolysis device that performs electrolysis of a NaCl aqueous solution stored in the reaction tank to generate a NaOH aqueous solution as the aqueous alkali metal hydroxide solution in the reaction tank; and
a solar power generating device that generates electric power from sunlight, and supplies the electric power to the electrolysis device.

18. The CO₂ recovery device according to claim 17, wherein the electrolysis device includes electrodes that are provided so as to be detachably attachable to the reaction tank.
